(19) United States
(12) Patent Application Publication
(10) Pub. No.: US 2009/0217830 A1
(43) Pub. Date: Sep. 3, 2009

(54) SCREEN PRINTER PRINT CARRIAGE

(75) Inventor: Otto Richard Eppinger, Braeside (AU)

Correspondence Address: CONNOLLY BOVE LODGE & HUTZ LLP, 1875 EYE STREET, N.W., SUITE 1100, WASHINGTON, DC, 20006, US

(73) Assignee: Reefdale PTY Ltd, Braeside (AU)

(21) Appl. No.: 12/393,379

(22) Filed: Feb. 26, 2009

(30) Foreign Application Priority Data
Feb. 29, 2008 (AU) AU2008900980

(51) Int. Cl. B41F 15/44

(52) U.S. Cl. 101/114

(57) ABSTRACT

A squeegee or flood bar for the print carriage of a screen printing machine which consists of a mounting bracket and blade portion in which the bracket portion is adapted for quick attachment and detachment to the print carriage and the bracket is attached to the blade portion on one side of the blade portion. The bracket attaches to one face of the blade near the upper edge and this offset position means that a change in the angle of inclination of the blade does not result in a large change in position of the bottom edge of the blade. The attachment means is preferably a toggle clamp on the carrier bar for the squeegee and flood bar. By simply releasing the toggle clamp the bracket and blade can be quickly removed and replaced.

### FIELD OF THE INVENTION

This invention relates to improvements in the print carriages of carousel screen printing machines

### BACKGROUND TO THE INVENTION

Carousel Screen printing machines are used for screen printing of garments and utilise a plurality of fixed print heads beneath which are positioned a plurality of garment support pallets which are moveable from one print head to the next. Each print head has a carriage mounted for reciprocal movement to move the flood bar and squeegee bars over the screen.

The flood bar and squeegee blades forming the print head in screen printing machines are mounted on a moving carriage with the flood bar down in the flood stroke and the squeegee down in the print stroke. The carriage is supported at both ends in a print frame and moves back and forth along the print frame. U.S. Pat. No. 5,189,950 discloses a centrally mounted print arm supporting a central portion of the carriage for reciprocal movement along the print arm. The carriage is pneumatically driven along the arm. An alternative to pneumatic drives is electric motor driven drive belts.

Conventionally the squeegee and flood bar on the print carriage are bolted in place and are difficult to remove. They are usually attached to the carriage from the top edge of the squeegee or flood bar. A typical arrangement is shown in U.S. Pat. No. 4,939,991.

U.S. Pat. No. 5,165,339 discloses a detachable scraper for a flood bar in which the top of the scraper blade is held in the flood bar holder.

U.S. Pat. No. 5,722,321 discloses a detachable squeegee blade which again is suspended from the top edge.

As the design of the rotary screen printing machines evolve ease of operation and reduction of fabrication costs are of increasing importance. Another desirable attribute is the ease with which screens and flood bar assemblies can be serviced and replaced.

It is an object of this invention to provide a squeegee and flood bar that is convenient to install adjust and remove, with minimum affect on the height and length of print stroke.

### BRIEF DESCRIPTION OF THE INVENTION

To this end the present invention provides a squeegee or flood bar for the print carriage of a screen printing machine which consists of a mounting bracket and blade portion in which the bracket portion is adapted for quick attachment and detachment to the print carriage and the bracket is attached to the blade portion on one side of the blade portion.

The attachment means is preferably a toggle clamp on the carrier bar for the squeegee and flood bar. By simply releasing the toggle clamp the bracket and blade holder can be quickly removed and replaced.

The bracket attaches to one face of the blade near the upper edge and this offset position means that a change in the angle of inclination of the blade does not result in a large change in position of the bottom edge of the blade.

### DETAILED DESCRIPTION OF THE INVENTION

Preferred embodiments of the invention will be described with reference to the drawings in which:

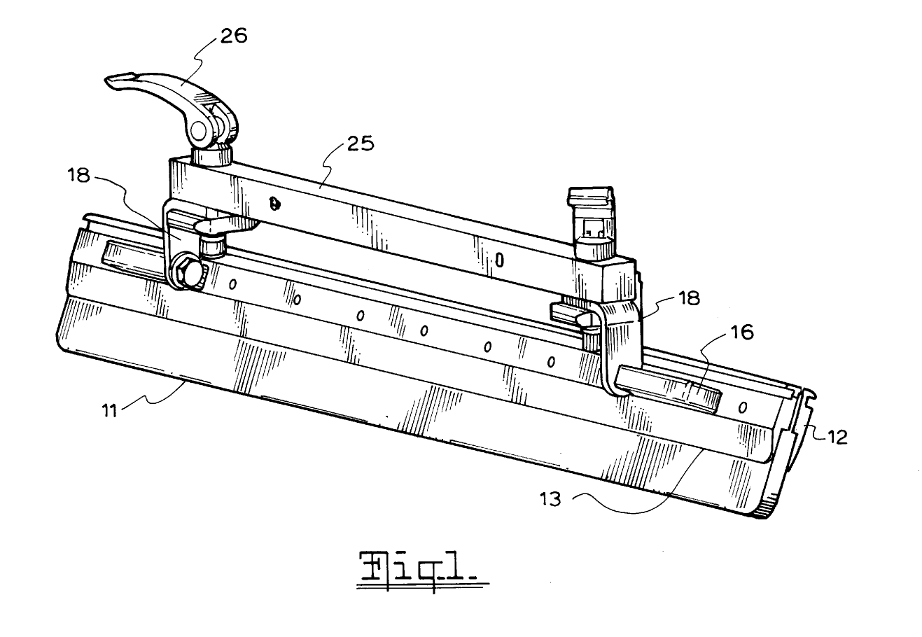

FIG. 1 is a view of a detachable squeegee blade according to an embodiment of this invention;

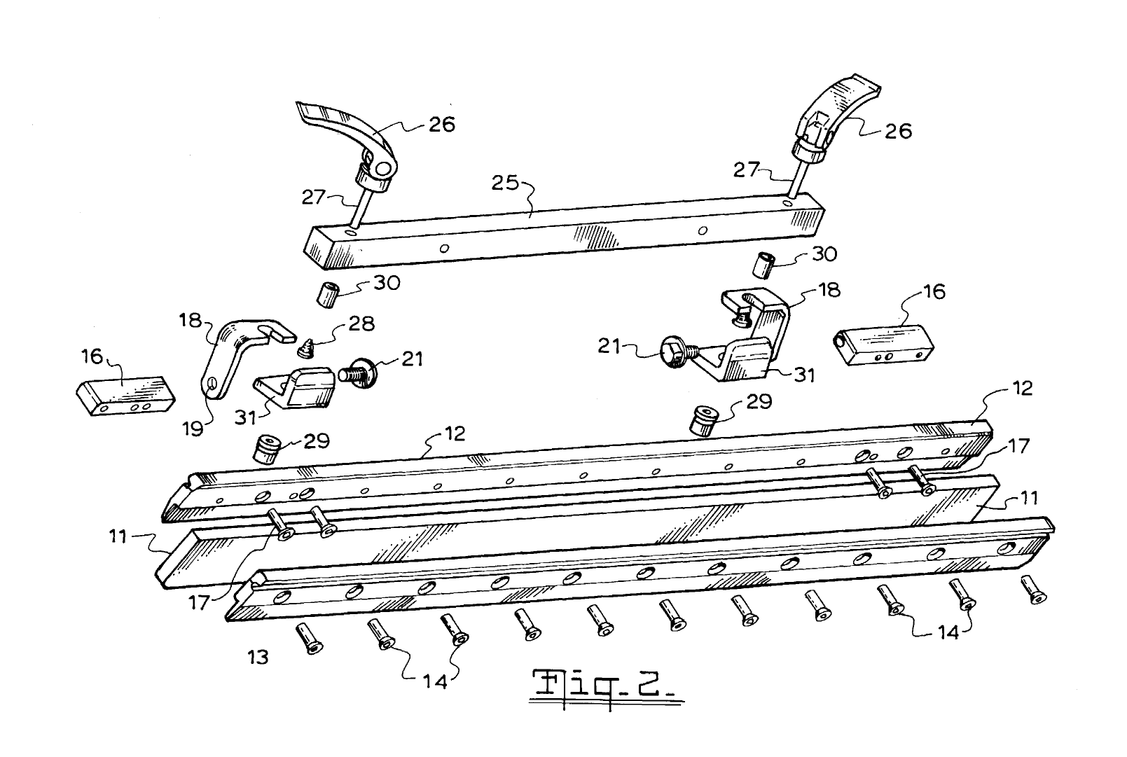

FIG. 2 is an exploded view of the blade of FIG. 1.

The flood bar or squeegee blade consists of the blade portion 11 and the blade holder frames 12 and 13 which are secured together with screws 14. Attached to frame 12 are the two pivot mounting blocks 16 secured by screws 17 to the frame 12. Mounting brackets 18 are secured to the mounting blocks 16 by pivot screw fasteners 21 at holes 19. The brackets 18 are L shaped and include a mounting slot 20 in the horizontal arm.

The squeegee and floodbar mounting bar 25 carries two toggle clamps 26 having shafts 27 that pass through holes in the bar 25 and carry the brass bushing 30. The end of shaft 27 carries the bracket 31 secured by adjustor nut 29. The spring 28 located about the shaft 27 provides the separating and leveling force between the mounting bar 25 and bracket 31, to allow easy installation of bracket 18.

The angle of inclination of the blade 11 can be adjusted by changing the relative angle between bracket 18 and the mounting block 16. The locknut 29 has a retaining washer to adjust the clamping force.

To attach the squeegee to the carrier bar 25 the slots 20 of the brackets 18 are located about the bushes 30 and the toggle clamped in place. The toggles can be turned so that the handles are tucked away from interfering in the operation of the carriage.

From the above it can be seen that this invention provides a unique squeegee or flood bar design that provides flexibility and ease in changing machine configurations.

Those skilled in the art will appreciate that the teachings of this invention may be implemented in other embodiments without departing from the core concepts of the invention.

1. A squeegee or flood bar for the print carriage of a screen printing machine which consists of a mounting bracket and blade portion in which the bracket portion is adapted for quick attachment and detachment to the print carriage and the bracket is attached to the blade portion on one side of the blade portion.

2. A squeegee as claimed in claim 1 in which toggle clamps are used to fasten the flood bar to the print carriage.

3. A squeegee or flood bar for the print carriage of a screen printing machine which includes at least one mounting bracket provided on the top edge of the squeegee or flood bar that include mounting slots to accommodate the shaft of a toggle clamp and at least one toggle clamp on the carrier bar of said print carriage to enable quick attachment and release of the flood bar or squeegee.

4. A squeegee or flood bar as claimed in claim 3 in which the at least one mounting bracket is secured to one side of the squeegee or flood bar and extends above the top edge of the squeegee or flood bar.
